(19) United States
(12) Patent Application Publication
(10) Pub. No.: US 2006/0038829 A1
(43) Pub. Date: Feb. 23, 2006

(54) Cad system, program for running the system, and recording medium having the program recorded therein

(76) Inventors: Kazuo Morichi, Hyogo (JP); Kazuyoshi Matsumoto, Hyogo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/532,501

(22) PCT Filed: Oct. 23, 2003
(86) PCT No.: PCT/JP03/13524

§ 371 Date: Apr. 25, 2005

(30) Foreign Application Priority Data
Oct. 25, 2002 (JP) 2002-311264
Apr. 24, 2003 (WO) PCT/JP03/05224

(51) Int. Cl. G09G 5/00

(52) U.S. Cl. 345/619

(57) ABSTRACT

The present invention provides a CAD system, a program for operating the system and a recording medium. The system is capable of automatically recognizing parts to be processed, from CAD data which only contains a product shape, and generating the shape of body to be processed and the work contents therefore.

The CAD system includes a processing information group (15) and a process definition group (18). The processing information group includes: a processed-body division (15a) which stores a part whose material substance is to be removed by a single or a series of processing operations, as a body for each of the process operations by pre-defined work instructions; and a process-contents division (15b) which stores information about work contents of each process operation in relation to the body. The process definition group contains definitions of a plurality of process operations. Upon selection from the process operations and parts to be processed (51′ through 59′) in an original product body (50′), shape information is extracted for each of the selected parts to be processed (51′-59′) and tools and parameters for processing the extracted shape are determined, a processed bodes (51-59) are generated, the generated processed bodies (51-59) are stored in the processed-body division (15a), and the determined tools and parameters are stored in the process-contents division (15b).

### TECHNICAL FIELD

The present invention relates to CAD systems, programs for operating the systems, and recording medium containing the programs.

### BACKGROUND ART

In a conventional CAD (Computer Aided Design) system such as “Automatic Programming Device and Method” disclosed in JP-A 10-207523, when a figure is created, processing information is specified simultaneously. According to this technique, several basic shapes are registered in advance, and by entering parameter values to these basic shapes, body data of a solid model which is to be removed is created. Then, by performing an arithmetic operation to delete the body data from the original body shape, a product shape is created.

However, CAD data which is delivered from the designer to the factory operator often contains only the product shape. In such a case, the operator who works on the CAD system described above must first create a body shape, and then input various parameters and so on for the processing. In the operation of CAD/CAM (Computer Aided Manufacturing) systems, this has been a factor which decreases work efficiency.

In addition, according to the conventional CAD system, bodies can only be made from the basic shapes which are already registered. When creating shape data of any non-registered part which is to be processed, a new basic shape must be created. Therefore, the system has not been suitable for complex processing under circumstances where the shape is subject to frequent changes.

Further, conventional CAD systems only projects a product shape which has resulted, without clear information about the process. Processing operations which have been performed are only shown as remarks for example. As a result, after a complex process of operations, it becomes difficult to tell specific steps through which the shape has been created. This leads to such problems of missing operations as well as performing unnecessary operations.

For a reference, here is a list of conventional techniques and their limitations.

First, JP-A7-182019 discloses “Processing Information Generating Device.” This relates to a simulator which performs set operations concerning a deleted shape and a product shape resulted from the deletion process, in order to restore an original body shape. As is clear from the statement “The deleted shape is not displayed” in Paragraph 0024 of the Gazette, the invention is not intended to store the deleted part as CAD data or display the part for use.

JP-A 2001-121383 and JP-A 2001-117616 disclose techniques, in which a shape after processing and an original shape are compared against each other for recognition of deleted parts and generation of NC data. Neither of the techniques is intended to create solid data for parts to be deleted so that the solid data can be utilized for correction/instruction for processing operations.

JP-A 6-266427 discloses a technique, in which merely a processing path is set, and the invention does not help grasp the contents of processing operations themselves.

In view of the circumstances described above, a first object of the present invention is to provide a CAD system, a program for operating the system and a recording medium, capable of automatically recognizing parts to be processed from CAD data which only contains a product shape, and generating the shape of body to be processed and the work contents therefore.

A second object of the present invention is to provide a CAD system, a program for operating the system and a recording medium, in which the operator can identify processing operations intuitively and clearly.

### DISCLOSURE OF THE INVENTION

In order to achieve the above objects, a CAD system according to the present invention includes a processing information group and a process definition group. The processing information group includes: a processed-body division which stores a part whose material substance is to be removed by a single or a series of processing operations, as a body (shape-body) for each of the process operations by pre-defined work instructions; and a process-contents division which stores information about work contents of each process operation in relation to the body. The process definition group contains definitions of a plurality of process operations. Selection from the process operations and parts to be processed in an original product body, shape information is extracted for each of the selected parts to be processed and tools and parameters for processing the extracted shape are determined, a processed bodes are generated, the generated processed bodies are stored in the processed-body division, and the determined tools and parameters are stored in the process-contents division.

In addition to the above described characteristics, preferably, the CAD system further includes a body display control unit which, upon selection from displayed processed bodies, displays work contents related to the processed body.

Further, preferably, the system displays area differences or an interference region if there is any area difference between the original product body and the processed bodies generated in correspondence with the parts to be processed or if an interference region exists between the processed bodies. Further preferably, the area difference and the interference region are displayed in respective colors or patterns specific to the kind. This enables intuitive grasp of design mistakes, processing mistakes and so on.

Preferably, work content data for each of the bodies stored in the process-contents division are attribute data of corresponding body data stored in the processed-body division. According to this characteristic, unlike conventions where body data and process attributes are stored per unit of process, work content data is stored as part of body data. This enables readily reference to the work contents, making possible to proceed with the operation quickly and efficiently.

A combination of a plurality of tools may be stored in a selectable-tool set as the pre-defined work instructions, for each kind of the bodies. Also, the pre-defined work instructions may be made per body, and may include a plurality of steps.

Displaying each of the bodies in a color or a pattern specific to the kind of machining will help visual identification of the work contents. Each piece of work content information stored in the process-contents division is an equivalent to a work instruction in a CAM, and deletion of any of the bodies causes deletion of the related work contents.

The CAD system may further includes body data control unit which, upon specifying and copying the body to another position, stores work contents for this another position in relation to the copy of the body.

The body data control unit may function as follows: Specifically, the process definition group may also include a plurality of the processing operations, and the body data control unit creates and displays on a specific area a body corresponding to a processing operation selected from the process definition group upon specification of a location on a drawing.

The present invention can be embodied into three-dimensional CAD systems as well as two-dimensional CAD systems. Three-dimensional display makes recognition of the body easy. The present invention can also be embodied into computer programs for executing any of the CAD systems described above, or recording medium containing the program for a computer for executing any of the CAD systems described above.

According to these characteristics of the CAD systems offered by the present invention, a part to be processed is selected, and then a body is extracted from CAD data of an original product shape. Because of this, input operation of the body has become easy. Further, process operation data for a part to be removed is generated even for a complex shape, based on the selected processing operation and the part to be processed. This drastically reduces the burden of inputting data. As a result of these, operation of the CAD/CAM system has become significantly efficient.

Further, by selecting any of the processed body, the operator can readily know the contents of processing operations, i.e. work instructions, which have been made to the body. Work contents such as tools to be used and the amount of cut can be varied conveniently. These have enabled to make instructions for more appropriate machining.

Other objects, arrangements and advantages of the present invention will become clearer from the following description.

### BRIEF DESCRIPTION OF THE DRAWINGS

FIG. 1 is a hardware configuration diagram of a three-dimensional CAD system.

FIG. 2 is a software configuration diagram of the three-dimensional CAD system.

FIG. 3 is a configuration diagram of a process definition group.

FIG. 4 is a display example on a monitor screen: FIG. 4(a) is a perspective view; FIG. 4(b) is a side view; and FIG. 4(c) is a front view.

FIG. 5 is a display example; parts of an original material which are to be removed by processing operations are displayed as bodies, with outlines of the original material.

FIG. 6 is a display example; the outlines of the material are not shown, and an input window is displayed.

FIG. 7 shows a tool list window.

FIG. 8 shows a selected-tool list window which lists tools selected for use.

FIG. 9 shows how tools in FIG. 8 are used for drilling a through hole: FIG. 9(a) shows a 3 mm-diameter center drill;

FIG. 9(b) shows a 9 mm-diameter drill; and FIG. 9(c) shows a 9.5 mm-diameter drill; and FIG. 9(d) shows a 10 mm-diameter reamer.

FIG. 10 shows a processing-operation procedure window in working on profile.

FIG. 11 shows how machining is made for each of the processing operations: FIG. 11(a) shows starting-hole drilling; FIG. 11(b) shows pocket making; FIG. 11(c) shows detail removal machining; and FIG. 11(d) shows outline machining.

FIG. 12 is a flowchart showing a generation procedure of a processed body and work contents.

FIG. 13 shows a bore finishing tool selection window.

FIG. 14 shows a selected-tool list window which is displayed after the bore finishing tool selection window in FIG. 13.

FIG. 15 shows area differences and an interference region as displayed in color.

### BEST MODE FOR CARRYING OUT THE INVENTION

Next, the present invention will be described in further detail while making reference to the attached drawings.

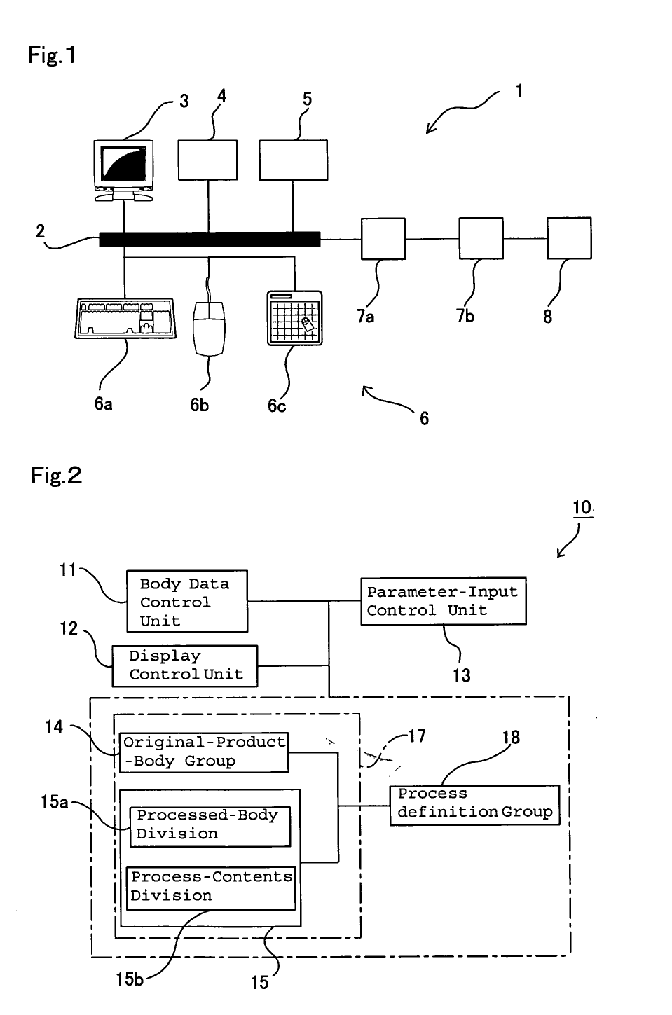

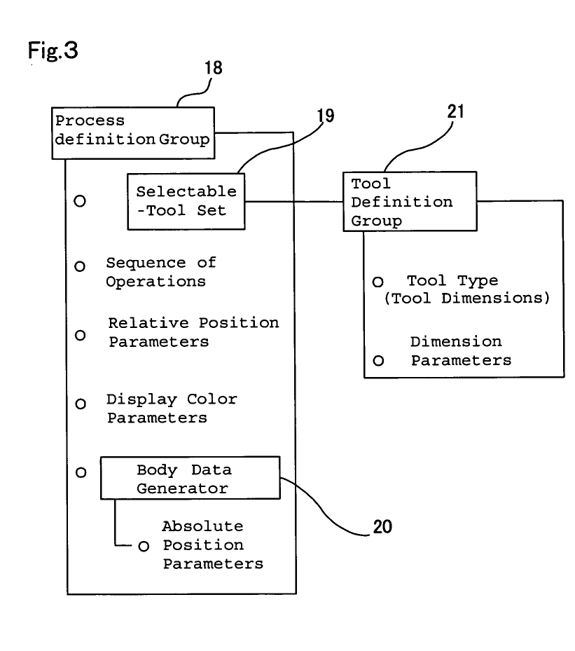

FIG. 1 shows a three-dimensional CAD system 1. This includes a bus 2 which has an address bus and a data bus, and is connected with a monitor 3, a CPU 4, a memory 5 and input devices 6 for the operator. The input device includes a keyboard 6a, a mouse 6b and a digitizer 6c. The memory 5 which is provided by a hard disc, RAM and so on, stores pieces of software shown in FIGS. 2 and 3. Commands from the input devices 6 are executed by the CPU 4 and results of operations are displayed on the monitor 3. Data created by the CAD are transferred as CAM data to NC equipment 8 via network adapters 7a, 7b, memory elements and so on, for machining operations.

FIGS. 2 and 3 show a software configuration 10 of the software for execution by the three-dimensional CAD system according to the present invention. The software configuration 10 includes object data memory means 14, 15, 18 which store main data. These object data memory means 14, 15, 18 are controlled by a display control unit 12 and a parameter-input control unit 13, and display is made on the monitor 3. Object data include individual drawing data 17 and a process definition group 18. The individual drawing data 17 includes an original-product-body group 14 and a processing information group 15. The processing information group 15 has, for each body to be removed, a processed-body division 15a which stores CAD data of the processed body, and a process-contents division 15b which stores data about the contents of processing operations.

Both of the original-product-body group 14 and the processing information group 15 are collections of CAD data and thus include a plurality of bodies. When working on the solid-base object, “bodies (shape-bodies)” include three kinds of shells: solid shell, surface shell and wire shell which does not have any surfaces and consists only of a wire. Thus, a body refers to any 2D/3D (plane/solid) figure which is made of these shells. When the object is surface-based, the body refers to any 2D/3D figure made of surfaces or wires.

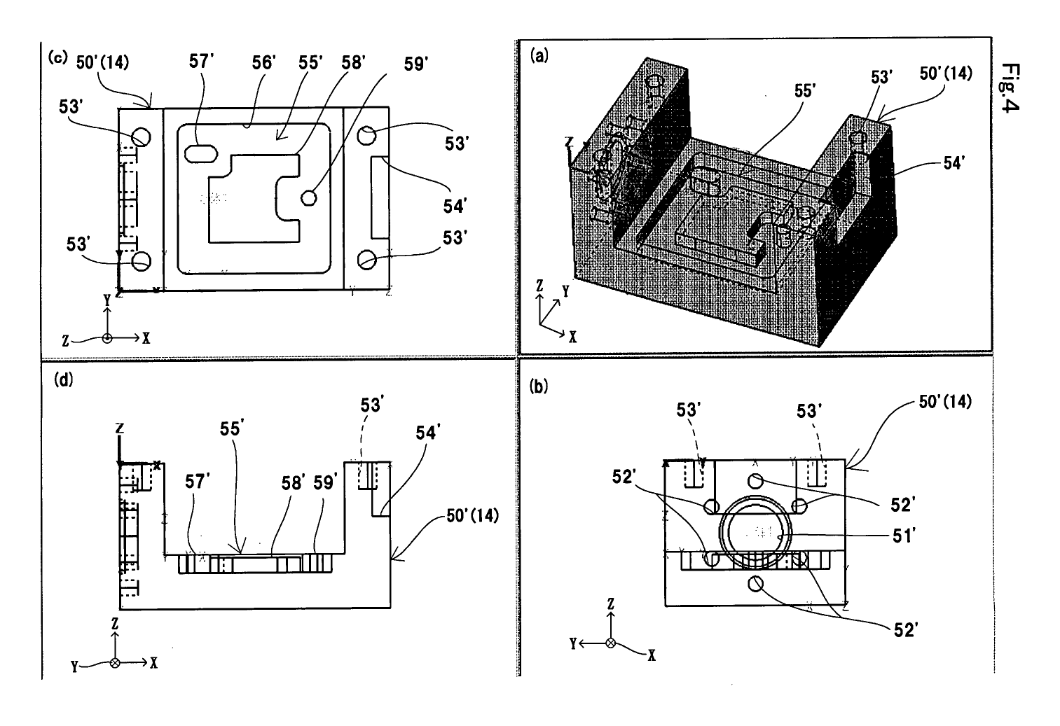

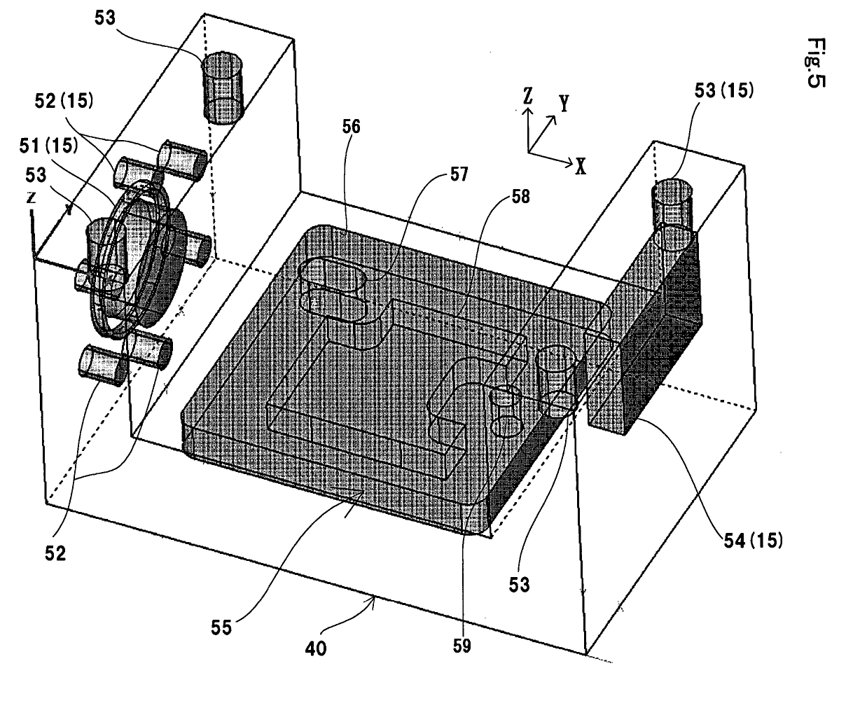

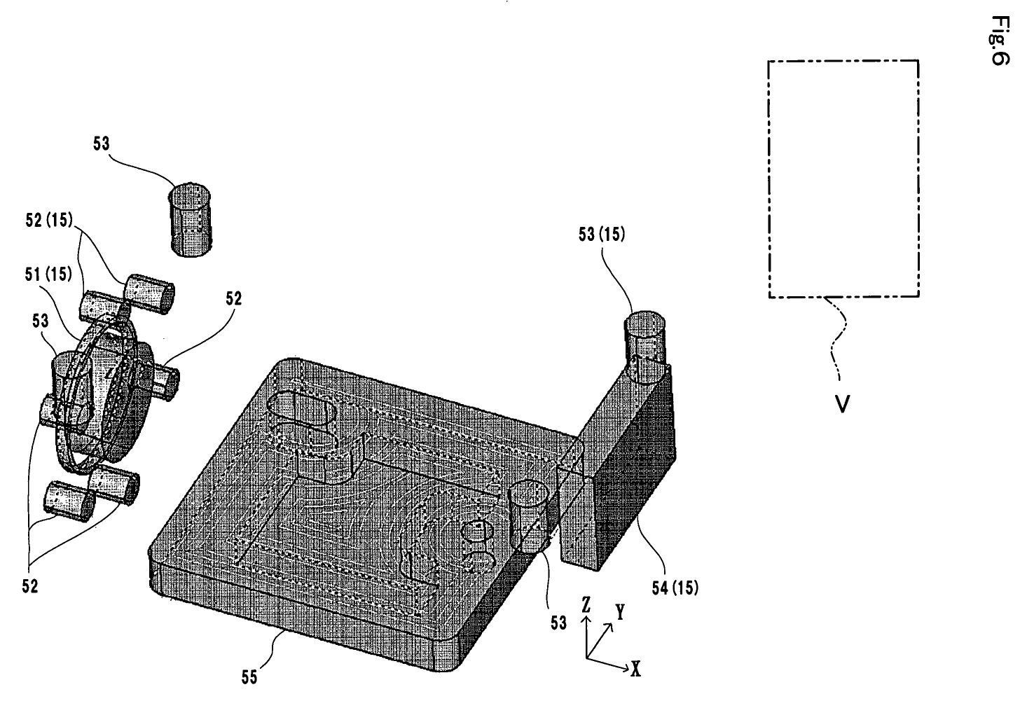

The original-product-body group 14 refers to an original product body 50′ which is before being processed into the final product shown in FIG. 4. In FIG. 4, reference codes 51′ through 59′ indicate parts of the original product body 50′ before being processed. These parts correspond to parts after being processed which are shown in FIGS. 5 and 6 and indicated by respective reference codes 51 through 59 without a prime.

The processed-body division 15a is a collection of bodies which are to be removed by processing operations. Each body is shown, e.g. in FIG. 5, as a large hole 51, a lateral hole 52, a vertical hole 53, a square cutout 54, profiled part 55 and such. The body in the processed-body division 15a is to show where material substance is to be removed, so it primarily consists of solid shells or surface shells if it is a solid model.

The process-contents division 15b is a collection of data stored as attribute data of a body for example, and includes a plurality of work contents. The content of each work is related to a corresponding one of the bodies stored in the processed-body division 15a. Normally, the processed-body division 15a and the process-contents division 15b are stored as part of the processing information group 15 which is a single CAD file, and are readily accessible from the related body to view the work contents.

The process definition group 18 is the original data of the process-contents division 15b, and contains a group of definitions for a plurality of kinds of works. In the process definition group 18, the operator can select “boring”, “drilling” or “profiling” for example, and then define parameters to specify the method of the work. As shown in FIG. 3, the process definition group 18 includes such parameters as a selectable-tool set 19, a sequence of operations, relative position parameters, display color parameters and a body data generator 20, for each of the works.

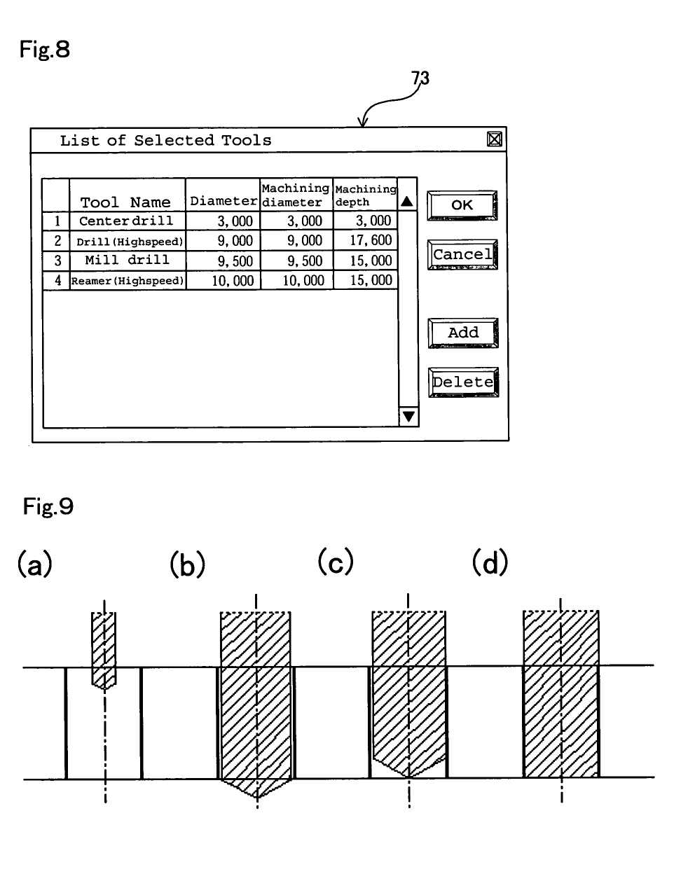

The selectable-tool set 19 is a set of tool data of a single or a plurality of tools selected from a tool definition group 21. The tool definition group 21 includes identification of the tool including tool dimensions, and the amount of work made by the tool, in the form of parameters. Examples of these parameters, in case of a drill, are dimension parameters such as the drill diameter and the hole depth. In the case of “through hole drilling”, as shown in an available-tool menu 73 in FIG. 8, three kinds of drill works and one reamer work are included, so four kinds of tools are included in the data of the selectable-tool set 19 or recorded as “pre-defined work instructions”.

Among the parameters in the process definition group 18, the sequence of operations indicates the order of machining by tools listed in the selectable-tool set 19. The relative position parameters determine relative positioning relationships between a plurality of tools.

The body data generator 20 has absolute position parameters. Once a specific part of the body is selected by using the input device 6, an absolute work position in the three-dimensional space is identified, and body data is created based on the other parameters described above. In the case of drilling a hole, the diameter of the drill to be used finally, the depth and the location of hole define an absolute shape in the space, and creating body data based on these is the only task to do. For example, if boring operation is selected and then the vertical hole 53′ is specified in FIG. 4, various parameters are obtained from the vertical hole 53′ which is part of the original product body 50′, and at the same time, a body of the vertical hole in FIG. 5, 6 or a cylindrical body is created. In other words, process definitions in the process definition group 18 are a sort of library which contains definitions made in accordance with the final shape to be made by the process, and thus it becomes possible to define a variety of shapes using combinations of the tool definition groups 21. It should be noted here that the object or the vertical hole 53′ may be specified first, withtheworkcontent or “boring” being selected thereafter.

Each data in the processed-body division 15a is accessible through the parameter input control unit 13: By selecting the object and a new location, the body data control unit 11 will create a copy at the specified location. During this process, the corresponding work contents for the new position is copied from the process-contents division 15b, and the work contents are modified according to the new location. Similarly, when body data is deleted through the parameter input control unit 13, the body data control unit 11 deletes the corresponding work contents in process-contents division 15b.

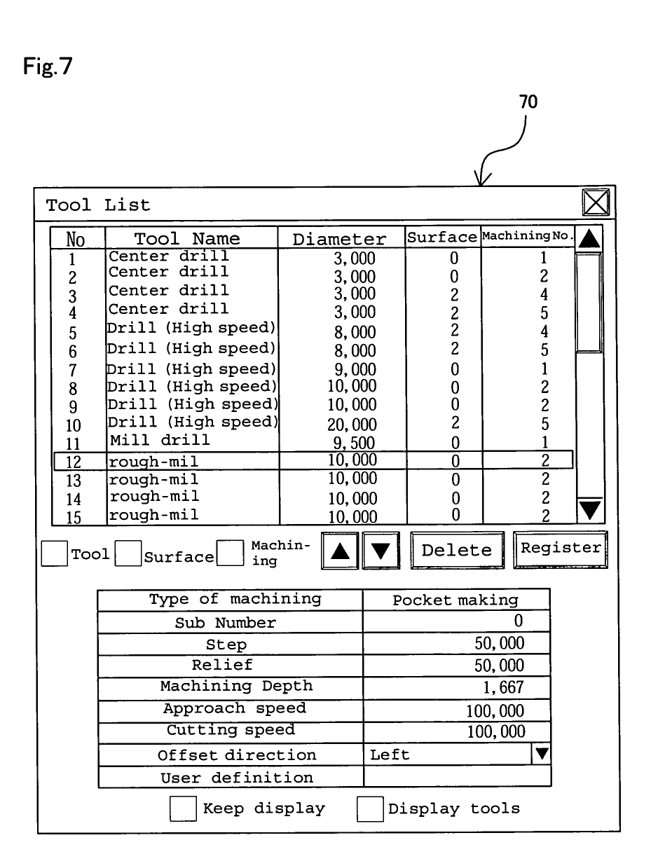

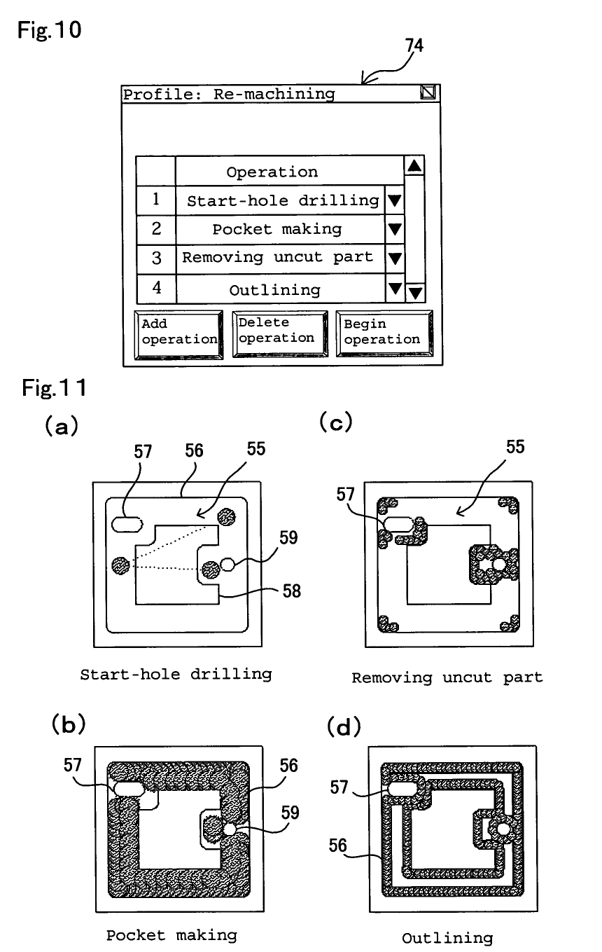

FIG. 4 shows the shape of a final product which has been processed. The method of display is conventional. The large hole 51, the lateral hole 52, the vertical hole 53 and the square cutout 54 are all relatively easy machining work classified in boring or cutting. The profiled part 55 is formed as a generally square cutout 56 as viewed from above, with a first elongated circular island 57 and a third circular island 59 being left, and a second island 58 which has its height reduced slightly. Parts indicated by reference codes 51 through 59 are each displayable as bodies as shown in FIGS. 5 and 6. The display control unit 12 and the parameter input control unit 13 control the process-contents division 15b, the process definition group 18 and the tool definition group 21, which appear, for example, as display windows such as a tool-list window 70 in FIG. 7, or display windows in FIGS. 8 and 10, on the monitor. The display control unit 12 uses different display colors for each of the processed bodies 51, 52, 53, 54 and 55, as specified by the display color parameters in the process definition group 18. Specifically, each body is displayed in a different display color depending upon the work contents and dimensional tolerance.

FIG. 7 shows a tool-list window 70 which is displayed, for example, in a box drawn in broken lines and indicated by a reference code V in FIG. 6. The tool-list window 70 displays a list of tools stored in the process definition group 21, with the “tool name” and the “tool diameter”, and the operator can scroll the list using a scroll bar and make choices therefrom. Once a tool is selected, work contents achievable with the tool is displayed in the bottom portion of the window 70. The example in the figure show a case in which the selection is made for No. 12 Rough-mil, and the display gives information that this Rough-mil tool is for a pocket making, and shows a table which lists various data including the dimension of a step to be created on the island, the depth of drilling and so on. By clicking a “Register” button or a “Delete” button, the operator can register or delete tool data. Windows, which are to be discussed later and shown in FIG. 8 and FIG. 10, may also be shown in the same box area V in FIG. 6, whereby it becomes easy to check work contents and giving work instructions.

FIG. 8 shows an example of definitions in the process definition group 18, for drilling works such as the large hole 51 and the vertical hole 53. Once selection is made for a tool for finishing the hole, in an unillustrated hole finishing tool selection window, the available-tool menu 73 lists the “tool names”, “drill diameters” and “drilling depths” of the available tools for this sequence of operations. The numbers 1 through 4 indicate the order of drilling works, which correspond to processing operations shown in FIGS. 9(a) though (d) respectively. In this particular boring, a center drill of a 3-mm diameter is used first to make a small hole. Then, a 9-mm high-speed-steel drill and a 9.5 mm drill are used one after the other, and finally, a 10-mm high-speed-steel reamer is used for a final finish. As exemplified, by specifying a working depth for each drilling operation according to the present invention, it becomes possible to perform appropriate machining. If such work contents are to be modified, the operator can click an “Add” or “Delete” button to make appropriate changes on the tools for example.

FIG. 10 shows a work sequence list window 74, which relates to contents of work instructions for the profiled part 55. “Preliminary machining”, “pocket machining”, “detail removal machining” and “outline machining” in this figure correspond to process operations shown in FIGS. 11(a) through (d). In the profile machining, if a large-diameter tool is used for pocket machining as shown in FIG. 11(b), certain parts are left uncut, such as angled or curved borders between the cutout and islands. Therefore, as shown in FIG. 11(c), a small-diameter tool is used to perform the detail removal machining. Further, as shown in FIG. 11(d), border areas between the cutout and the islands are smoothened by the outline machining. By specifying tools and various parameters for each machining operation, it becomes possible to do precise profile machining. There is still another window called profile definition window, which displays parts for which work instructions have been made, i.e. the cutout 56, the first island 57, the height difference and depth of machining to the the second island 58. Further, an outline shape is defined for each island.

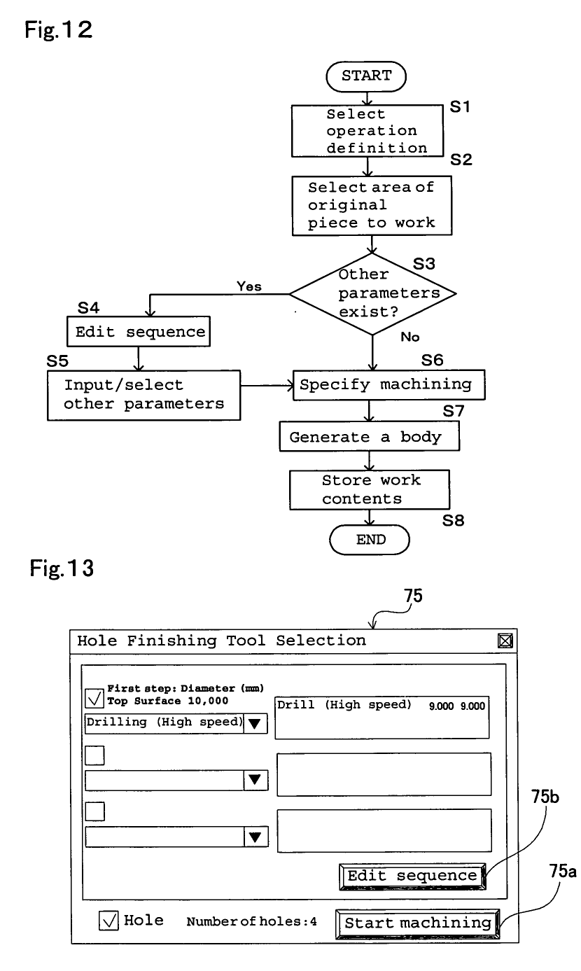

Now, description will cover how to use the CAD system according to the present invention, with reference to FIG. 12 through 14. First, the operator makes a selection from an unillustrated menu; from “boring” (including through holes and bottomed holes), “profile machining”, “surface machining” and other process definitions, in the process definition group 18 (S1), and then selects work areas 51′ through 55, as shown in FIG. 4 which are areas where the processing operations are to be made (S2). The selections made here represent the input of absolute position parameters in the body data generator 20. Display screens shown in FIG. 4 as well as FIGS. 5 and 6 can be toggled back and forth as needed.

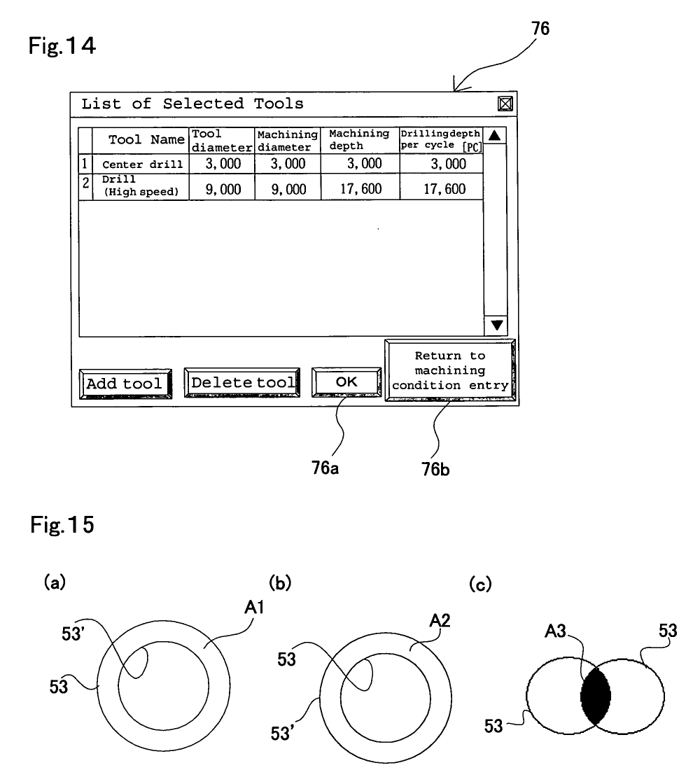

If the selection is made for the vertical hole 53′, no other parameters are needed than already set in the process definition group 18 (S3). Thus, a hole finishing tool selection window 75 in FIG. 13 is used to select a Machining Start Button 75a (S6). Upon the selection, displayed is an available tool-list window 76 shown in FIG. 14, and selection of an OK Button 76a generates bodies 51 through 59 as shown in FIGS. 5 and 6 (S7). Further, the process-contents division 15b stores contents as shown in FIGS. 8, 10, 14, etc. (S8).

On the other hand, when input must be made for other parameters as in the case of the profiled part 55′ (S3) a clicking is made on the outline of profiled part 55′ in FIG. 4. With the clicking, a range of the profile machining is specified. In a profile machining selection window 74 shown in FIG. 13, an unillustrated machining-sequence edition button 74b is selected (S4), and locations of e.g. the cutout 56′, the first island 57′ and the second island 58′ are inputted with a mouse or through number input (S5). Steps after the work instructions (S6) are the same as in the case of boring which has been described above; specifically, an automatically created processed body 55 is stored in the processed-body division 15a (S7), and the contents of the processing operations are stored in the process-contents division 15b in the sequence as shown in FIGS. 11(a) through (d) (S8).

Upon selection of a processed body in FIGS. 5 and 6, work contents related to the selected body are selected from the process-contents division 15b, and the display control unit 12 displays the contents on the monitor 3. For example, in FIGS. 5 and 6, if the lateral hole 52, the vertical hole 53 and so on are selected via the input device 6, the system will give a display such as in FIG. 8.

Further, if selection is made for apart of those regions indicated by reference codes 56 through 59 in the profiled part 55, a screen as shown in FIG. 10 is generated, which will help confirm the contents of the processing operations performed. Further, conversely, upon specifying a tool in the tool-list window 70 shown in FIG. 7, the display control unit 12 will display a corresponding body to be made with the specified tool, through relational links with the tool definition group 21, the selectable-tool set 19, the process definition group 18, the process-contents division 15b and the processed-body division 15a.

In FIGS. 5 and 6, there is a plurality of the lateral holes 52 and the vertical holes 53, of the same shape in their respective categories. Therefore, the operator can simply place one, and then make copies for the others. By using the body data control unit 11 and the display control unit 12, machined bodies and work contents are generated.

When checking the works, all that is needed is to fit all the processed bodies 51 through 59 onto the original product body 50′. If there is no processing error, and the fitting is complete, then a result is the original body 40. For example, as shown illustratively in FIG. 15(a), assume that the original product shape has a part to be processed or a vertical hole 53′, and this has been made smaller than the diameter of the vertical hole 53 or the body of the processed-body division 15a. In such a case, the area difference A1 between the two holes 53, 53′ may be indicated in a specific color. This enables easy perception of the processing mistake, and prevention of actual machining mistakes. Likewise, color-coded display should also be made in a case as shown in FIG. 15(b) if a processed body or the vertical hole 53 has a smaller diameter than that of the vertical hole 53′ of the original product body 50′. In this case a region A2 which indicates insufficient removal of material is emphasized with a color. Further, as shown in FIG. 15(c), if two vertical holes 53, 53 interfere with each other, the interference region A3 should also be displayed in a specific color. Each of these three kinds, i.e. the area differences A1, A2 and the interference region A3 may be displayed in a specific color which is different from each other, then it becomes possible to recognize design errors and causes of machining mistakes at a glance.

Finally, reference will be made for possibilities for other embodiments.

In the embodiment described above, a system according to the present invention is embodied in a single computer. However, the system may be a network system involving a plurality of computers. Also, color coding of each processed body may be replaced by different hatching patterns or other surface patterning.

In the embodiment described above, the processed-body division 15a and the process-contents division 15b are recorded as CAD data in a single file; however they may be stored in separate files. In such a case, a relationship may be defined between the processed-body division 15a and the process-contents division 15b, so that selection of a body will immediately enable work contents to be displayed.

In the embodiment described above, the present invention is embodied as a three-dimensional CAD system. However, the system may be a two-dimensional CAD system, although three-dimensional CAD systems are superior in terms of intuitive operation and automatic input of complete manufacturing data.

In the embodiment described above, the body data generator 20 obtains parameters and creates body data when a specific body part of the original product body 50′ is selected with the input device 6. Alternatively, parameters may be entered directly without specifying a body part.

In the embodiment described above, each of the processed bodies 51 through 59 is not necessarily identical with their respective original bodies which are indicated by the reference codes 51′ through 59′. For example, if the original body is a tapered drill hole and this hole is to be represented by a cylindrical processed body, then the outline of the processed body is displayed larger than the outline of the original body which has a tapered tip. In this case, not all volume of the processed body is removed in the actual machining. On the other hand, if an original body is displayed as a tapered drill hole and this hole is to be a cylindrical hole made by a milling operation, then again, the outline of the processed body is displayed larger than the outline of the original body, but in this latter case, all volume of the processed body is removed.

Reference codes seen in the claims are solely for the convenience in making reference to the drawings, and these codes do not limit the present invention to the configuration depicted in these drawings.

### INDUSTRIAL APPLICABILITY

The present invention can be used as a CAD system or a CAD/CAM system which is capable of storing and displaying work contents.

1-12. (canceled)

13. A CAD system comprising a processing information group and a process definition, the processing information group including: a processed-body division which stores a part whose material substance is to be removed by a series of processing operations, as a body for each of the process operations by pre-defined work instructions given via an input device; and a process-contents division which stores information about work contents of each process operation in relation to the body, the process definition group containing definitions of a plurality of process operations, upon selection from the process operations via the input device and selection of parts as CAD data to be processed via the input device in an original product body, shape information is extracted from the original product body based on the work instructions for each of the selected parts to be processed and tools and parameters for processing the extracted shape are determined based on the selected processing operations and the extracted shape information, processed bodies as CAD data are generated separately from the parts to be processed, the generated processed bodies are stored in the processed-body division, and the determined tools and parameters are stored in the process-contents division.

14. A CAD system comprising a processing information group and a process definition group, the processing information group including: a processed-body division which stores a part whose material substance is to be removed by a series of processing operations, as a body for each of the process operations by pre-defined work instructions given via an input device; and a process-contents division which stores information about work contents of each process operation in relation to the body, the process definition group containing definitions of a plurality of process operations, upon selection from the process operations via the input device and selection of parts as CAD data to be processed via the input device in an original product body, shape information is extracted from the original product body based on the work instructions for each of the selected parts to be processed and tools and parameters for processing the extracted shape are determined based on the selected processing operations and the extracted shape information, processed bodies as CAD data are generated separately from the parts to be processed, as shapes which do not match as after profiling operation or other process operations, the generated processed bodies are stored in the processed-body division, and the determined tools and parameters are stored in the process-contents division.

15. The CAD system according to claim 13 or 14, wherein a variety of shapes are defined by using combinations of the tool definition groups.

16. The CAD system according to claim 13 or 14, wherein the process definition group includes a plurality of the processing operations.

17. The CAD system according to claim 13 or 14, wherein a combination of a plurality of tools is stored in a selectable-tool set as the pre-defined work instructions, for each kind of the bodies.

18. The CAD system according to claim 13 or 14, wherein work content data for each of the bodies stored in the process-contents division are attribute data of corresponding body data stored in the processed-body division.

19. The CAD system according to claim 13 or 14, further comprising a body display control unit which, upon selection from displayed processed bodies, displays work contents related to the processed body.

20. The CAD system according to claim 13 or 14, wherein the system displays area differences or an interference region if there is any of the area differences between the original product body and the processed bodies generated in correspondence with the parts to be processed, or if the interference region exists between the processed bodies.

21. The CAD system according to claim 20, wherein the area differences and the interference region are displayed in respective colors or patterns specific to the kind.

22. The CAD system according to claim 13 or 14, wherein each piece of work content information stored in the process-contents division is an equivalent to a work instruction in a CAM, deletion of any of the bodies causing deletion of the related work contents.

23. The CAD system according to claim 13 or 14, further comprising a body data control unit which, upon specifying and copying the body to another position, stores work contents for this another position in relation to the copy of the body.

24. The CAD system according to claim 13 or 14, wherein the process definition group includes a plurality of the processing operations, the system further comprising a body data control unit which creates and displays on a specific area a body corresponding to a processing operation selected from the process definition group upon specification of a location on a drawing.

25. The CAD system according to claim 13 or 14, wherein the system makes three-dimensional display.

26. A computer program for operating the CAD system according to claim 13 or 14.

27. A recording medium containing a computer program for operating the CAD system according to claim 13 or 14.
